(19) United States
(12) Patent Application Publication
(10) Pub. No.: US 2010/0185684 A1
(43) Pub. Date: Jul. 22, 2010

(54) HIGH PRECISION MULTI ENTITY EXTRACTION

(76) Inventors: Amit Madaan, Kanpur (IN); Charu Tiwari, Bhopal (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/351,676

(22) Filed: Jan. 9, 2009

(51) Int. Cl. G06F 17/30

(52) U.S. Cl. 707/803; 707/E17.008

(57) ABSTRACT

Techniques for high precision multi entity extraction are provided. A wrapper that represents a generalized structure of a set of training web pages is accessed. The wrapper includes one or more annotations that indicate a set of attributes that are included in each of a plurality of records. Record boundaries are determined based on nodes included in the wrapper, where the record boundaries delimit the plurality of records within any training page of the set of training web pages. The wrapper is modified to include one or more boundary nodes, where the one or more boundary nodes indicate the record boundaries of the plurality of records within the set of training web pages. Multiple records are extracted from a web page, where extracting the multiple records comprises detecting record completions based at least on the wrapper and on a document object model (DOM) representation of the web page.

### CROSS-REFERENCE TO RELATED APPLICATIONS

The present application is related to U.S. patent application Ser. No. 11/938,736, filed on Nov. 12, 2007 and entitled “Extracting Information Based On Document Structure And Characteristics Of Attributes”, the entire contents of which are hereby incorporated by reference as if fully set forth herein.

The present application is related to U.S. patent application Ser. No. 11/945,749, filed on Nov. 27, 2007 and entitled “Techniques For Inducing High Quality Structural Templates For Electronic Documents”, the entire contents of which are hereby incorporated by reference as if fully set forth herein.

The present application is related to U.S. patent application Ser. No. 12/114,568, filed on May 2, 2008 and entitled “Generating Document Templates That Are Robust To Structural Variations”, the entire contents of which are hereby incorporated by reference as if fully set forth herein.

### FIELD OF THE INVENTION

The present invention relates to processing information and, in particular, to extracting information from structured electronic documents.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The Internet is a worldwide system of computer networks and is a public, self-sustaining facility that is accessible to tens of millions of people worldwide. The most widely used part of the Internet is the World Wide Web, often abbreviated “www” or simply referred to as just “the web”. The web is an Internet service that organizes information through the use of hypermedia. Various markup languages such as, for example, the HyperText Markup Language (“HTML”) or the “eXtended Markup Language (“XML”), are typically used to specify the contents and format of a hypermedia document (e.g., a web page). In this context, a markup language document may be a file that contains source code for a particular web page. Typically, a markup language document includes one or more pre-defined tags and their properties, and text content enclosed between the tags.

Today, a plethora of web portals and sites are hosted on the Internet in diverse fields like e-commerce, boarding and lodging, and entertainment. Information on these web sites is usually presented in uniform format to give uniform look and feel of the web pages therein. The uniform appeal is usually achieved by using scripts to generate the static content and structure of the web pages, and a database is used to provide the dynamic content. Automatic extraction from such sites becomes important for applications requiring extraction of information from a large number of web portals and sites.

The extraction task becomes more challenging when multiple entities like products and search results are presented in the form of records on a single web page. If the structure of the records is strictly-continuous, i.e. information in every record is identically formatted, existing nested pattern detection algorithms would suffice to detect the records within the web page. However, the records and the entities stored therein do not always follow a strict structure or pattern, hence requiring detection of approximate patterns. This is because, even though the structure of the records may remain largely similar, the entity information within the records may be formatted differently.

For example, a product description in one record could be plain text, while in other records it could have formatting tags indicating additional text features such as font types and font sizes. Further, the presence of optional information in a record such as a discount price in addition to the original price, or the absence of rating-image in a record where rating was not available, can contribute to structural differences between two records within the same web page. These differences, if not accounted for, could lead to low recall extraction when multiple entities need to be extracted from multiple records in a web page. Further, if the web page is processed in its Document Object Model (DOM) format, a record need not always be a single sub-tree but could be made up of multiple sibling sub-trees. To exacerbate the problem, the sub-trees of different records can appear together as siblings, making it difficult to detect the record boundaries.

### BRIEF DESCRIPTION OF THE DRAWINGS

In the figures of the accompanying drawings like reference numerals refer to similar elements.

FIG. 1 is a flow diagram that illustrates a method for high precision multi entity extraction according to an example embodiment.

FIG. 2A is a block diagram that illustrates a DOM representation of a portion of a web page.

FIG. 2B is a block diagram that illustrates a portion of a wrapper, according to an example embodiment, that corresponds to the DOM representation illustrated in FIG. 2A.

FIG. 2C is a block diagram that illustrates a DOM representation of a portion of a web page that includes multiple entities in a repeating pattern.

FIG. 2D is a block diagram that illustrates a portion of a wrapper, according to an example embodiment, that corresponds to the DOM representation illustrated in FIG. 2C.

FIG. 3A is a block diagram that illustrates a DOM representation of a portion of a web page that includes multiple entities.

FIG. 3B is a block diagram that illustrates a portion of a wrapper, according to an example embodiment, that corresponds to the DOM representation illustrated in FIG. 3A.

FIG. 4A is a block diagram that illustrates a DOM representation of a portion of a web page that includes multiple entities.

FIG. 4B is a block diagram that illustrates a portion of a wrapper, according to an example embodiment, that corresponds to the DOM representation illustrated in FIG. 4A.

FIG. 5 is a block diagram that illustrates an example computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques for high precision multi entity extraction from web pages are described. As used herein “web page” refers to an electronic document that is stored in, or can be otherwise provided by, a web site. A web page may be stored as a file or as any other suitable persistent and/or dynamic structure that is operable to store an electronic document or a collection of electronic documents. Typically, web pages can be rendered by a browser application program and can also be accessed, retrieved, and/or indexed by other programs such as search engines and web crawlers. A web page can include various types of content including, but not limited to, source code in one or more markup languages such as HTML and XML, embedded images and/or references thereto, embedded audio/video content and/or references thereto, and other embedded documents and/or references thereto such as other web pages and files of various types.

The techniques described herein provide for detecting and precisely extracting multiple entities that may be stored as multiple records in a web page, even when there are variations in the structure of the entities. As used herein, both “record” and “entity” refer to a grouping of attributes that represents a content item of interest. The techniques described herein may be used in conjunction with techniques for approximate pattern detection in order to process multiple records, where each record is processed separately by using a filtering framework to learn variations in the record's attributes and to extract the values of the desired attributes. Such combination of techniques for detecting multiple records with techniques for approximate pattern detection improves record boundary identification and subsequently results in higher precision and recall of any extracted records.

According to an example embodiment of the techniques described herein, a wrapper that represents a generalized structure of a set of training web pages is accessed or is otherwise generated. As used herein, “wrapper” refers to a regular expression that is learned over the structure of one or more web pages. (A wrapper may also be referred to as a “template”.) The wrapper includes one or more user-specified annotations that indicate a set of attributes that are included in each of a plurality of records. Record boundaries are then determined based on nodes included in the wrapper. The record boundaries delimit the plurality of records within any training page of the set of training web pages. The wrapper is then modified to include one or more boundary nodes, where the one or more boundary nodes indicate the record boundaries of the plurality of records within the set of training web pages. Multiple records are then extracted from a web page, where extracting the multiple records comprises detecting the record boundaries based at least on the wrapper and on a document object model (DOM) representation of the web page.

### Functional Description of an Example Embodiment

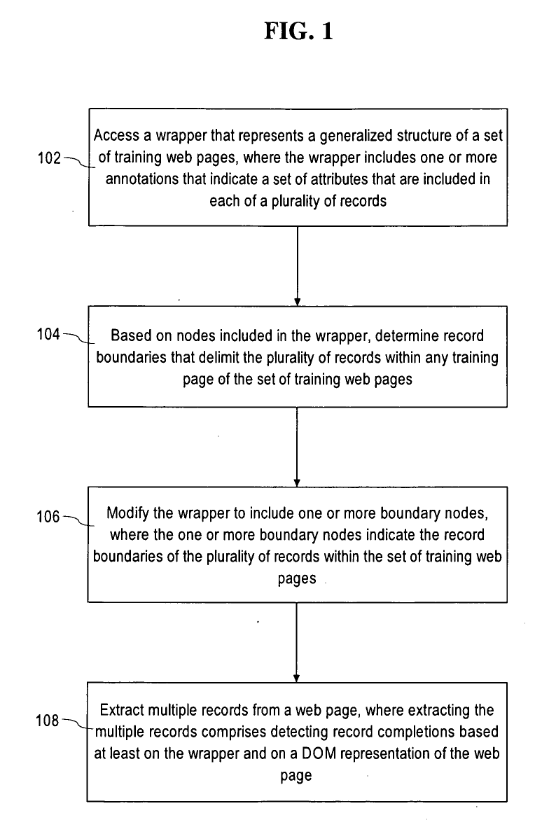

FIG. 1 is a flow diagram that illustrates an example method for high precision multi entity extraction according to the techniques described herein.

In step 102, a wrapper that represents a generalized structure of a set of training web pages is accessed. The wrapper includes one or more user-specified annotations that indicate a set of attributes that are included in each of a plurality of records, where the plurality of records are themselves stored in one or more of the set of training web pages.

For example, in one embodiment several web pages from a particular web site may be used as training web pages based on which a wrapper is determined and generated. A DOM representation may be generated for each of the training web pages, and an initial wrapper that represents the generalized structure of the training web pages may be generated from the page DOM representations. The initial wrapper may be a regular expression in a tree format that includes hierarchically organized nodes. Thereafter, a user may mark on one or more of the training web pages any page regions and/or attributes that are of interest. User input, which includes one or more annotations that indicate the marked page regions and/or attributes, is received and is recorded with respect to the corresponding page DOM representation. The annotations from the page DOM representation are then mapped to, and stored in association with, the corresponding nodes from the initial wrapper.

In step 104, record boundaries are determined based on the nodes included in the wrapper. The record boundaries delimit the plurality of records within any given training web page, where each record stores the set of attributes that the user has marked as being of interest. For example, in one embodiment, the annotated wrapper is examined and the lowest common ancestor (LCA) nodes are identified for those wrapper nodes that are annotated as corresponding to attributes of interest. The LCA nodes are then marked as boundary nodes that indicate record boundaries that delimit one record from another record on the same training web page. Where multiple repeating records appear under the same parent node in the DOM representation of the training web page, there will be a special STAR node in the wrapper which will be marked as the boundary node to delimit the multiple records from one another and to represent the pattern or patterns according to which the multiple records appear on the training web page.

In step 106, the wrapper is modified to include the one or more boundary nodes that represent the record boundaries determined in step 104. In the modified wrapper, the one or more boundary nodes indicate the record boundaries of the plurality of records that are present in the set of training web pages from which the wrapper is generated. For example, in one embodiment the wrapper is modified to include as boundary nodes any LCA nodes, including any STAR nodes, that indicate the detected record boundaries. Where the record boundaries of multiple repeating records are identified by a STAR node, the STAR node is present in the wrapper as the parent node of the multiple repeating records in conformance with the pattern according to which the multiple repeating records appear in the underlying training web pages.

In step 108, multiple records are extracted from a web page, where extracting the multiple records comprises detecting record completions based at least on the wrapper and on a DOM representation of the web page. As used herein, record “completion” refers to the end of a record, which is detected during the process of extracting the record from the underlying web page. The web page from which the multiple records are extracted may be one of the training web pages, or it may be a different, non-annotated page to which the wrapper is applied. For example, in some embodiments, step 108 may be performed on a training web page during a learning phase in which a set of training web pages are used to generate an accurate annotated wrapper and to perform accurate record boundary detection of repeating records within the set of training web pages. In another example, in some embodiments, step 108 may be performed during an extraction phase in which the wrapper is applied to extract records from non-annotated web pages that have page structures that are similar to the page structures of the training web pages from which the wrapper was generated. In these embodiments, some additional steps may be performed in order to first find a particular wrapper that represents a generalized structure that is similar to the structure of the web page being extracted from, and then to apply the found particular wrapper to the web page in accordance with the techniques described herein in order to extract multiple records from the web page.

It is noted that after the multiple records are extracted from a web page in accordance with the techniques described herein, the extracted records may be stored in any suitable computer data storage. For example, the extracted records may be persistently stored in a data repository such as, for example, a relational or object-relational database. In another example, the extracted records may be stored in one or more logical data structures in dynamic memory in the form of web page snippets (e.g., in a format that preserves HTML tagging) in order to facilitate further processing, capturing, and extraction of attribute values from the attributes of the records.

It is also noted that the techniques described herein for high precision multi entity extraction may be performed by a variety of software components and in a variety of operational contexts. For example, in one operational context, the steps of the method illustrated in FIG. 1 may be performed by one or more modules of a search engine that is operable to retrieve or otherwise traverse web sites hosted on a wide-area network such as the Internet or on a local network such as a corporate intranet. The search engine may include, in one or more modules, logic in the form of a set of executable instructions which, when executed by one or more processors, are operable to perform the functionalities for high precision multi entity extraction described herein. For example, the logic may be operable in accordance with the techniques described herein to generate annotated wrappers, to detect record boundaries, to modify the wrapper to reflect the record boundaries, and to use the modified wrapper to extract multiple records from annotated or non-annotated web pages that have been located and indexed by other modules of the search engine, such as a web crawler and an indexing component.

In other operational contexts, the techniques described herein and, in particular, the steps of the method illustrated in FIG. 1 may be performed by logic that is included in the form of executable instructions in a standalone software application or in the client and/or server component of a client-server application. In various embodiments any logic operable to perform the techniques described herein in general, and the steps of the method illustrated in FIG. 1 in particular, may be implemented as components of various types including, without limitation, as one or more software modules, as one or more libraries of functions, as one or more dynamically linked libraries, as one or more active X controls, and as one or more browser plug-ins. Thus, the techniques described herein for high precision multi entity extraction may be performed by a variety of software components and in a variety of operational contexts, and are not limited to being implemented and/or performed by any particular type of software component or in any particular operational context.

### Wrapper Generation

According to the techniques described herein, a wrapper representing a generalized page structure is generated from a set of structurally similar pages, which are also referred to herein as a set of training web pages. During the generation of the wrapper, logical records, which may include some structural variations like differences in formatting tags and which repeat within a web page according to some particular pattern, are merged under a single STAR node. As used herein, “pattern” refers to a page structure that repeats within a web page. “STAR node” refers to a wrapper node that represents the repetition of records within a web page; when the wrapper is represented as a regular expression tree, a STAR node may be inserted in the wrapper as the parent node of those wrapper nodes that form the repeating records.

In an example embodiment, a wrapper may be generated according to the techniques that are described in co-pending U.S. patent application Ser. No. 12/114,568, filed on May 2, 2008 and entitled “Generating Document Templates That Are Robust To Structural Variations”, the entire contents of which are hereby incorporated by reference as if fully set forth herein, and which is referred to hereinafter as the “'568 application”. The techniques described in the '568 application provide for finding approximate patterns in a web page that has multiple records having slightly varying structures. An example of an approximate pattern would be a list of products provided on a shopping web site, where in a first record a product title is followed by a discount price, but in a second record the discount price is missing. So given the web pages from such a shopping site, the techniques in the '568 application provide for finding such approximate patterns and representing them with a STAR node in such a way that these approximate patterns are captured in the corresponding wrapper.

In order to generate a wrapper from the web pages of such shopping web site, in one embodiment, a first pattern is learned from a first training page and then the pattern is analyzed with respect to the other web pages that selected from this web site as training pages. For example, an initial wrapper is generated from the first training page, and then an attempt is made to match this initial wrapper against the page structures in the second training page, the third training page, and so on. When a mismatch is found for any subsequent training page, the mismatch is determined and resolved by using three new operators—a STAR operator, an OP (or optional) operator, and an OR (or disjunction) operator. The STAR operator determines all the built-in repetitions of the page structures in the web page being examined, and inserts a STAR node over the corresponding repeating nodes in the wrapper. The OP operator determines if some of the tags and structure in the web page being examined are optional and marks these tags/attributes as optional in the corresponding wrapper nodes for the purpose of forward matching. The OR operator assembles as a single wrapper node those page structures, from the web page being examined, which can occupy any particular position within the wrapper. At the end of this process of matching the initial wrapper to the page structures of the subsequent training pages, a wrapper that represents the generalized structure of the set of training web pages is generated.

### Attribute Annotation

After generating a wrapper, according to the techniques described herein, the record attributes of interest are indicated on a subset of the training pages that are used to generate the wrapper. The record attributes of interest may be marked, or otherwise indicated, in a given web page by using manual or automated labeling mechanisms. The techniques described herein can then be used to precisely extract the values of the attributes of interest from other web pages that have similar page structure but have not been annotated or labeled. The locations of the record attributes of interest are stored as annotations to the corresponding nodes in the DOM representation of the web page being annotated. The annotations in the page DOM representation are then mapped, and transferred, to the corresponding nodes of the wrapper that represents the generalized structure of the web page.

As an operational example, one may consider a shopping web site that can provide search results for a particular product (e.g., a digital camera) in the form of a list that can span multiple web pages. A grouping of product attributes (e.g., camera name, model, make, description, price, etc.) for a particular listed product constitutes a record, and there may be multiple groupings of such attributes for multiple products that are returned in the web pages from the shopping web site. After a wrapper is generated from the set of training web pages from this shopping web site, a user may be provided with a graphical user interface (GUI) that is operable to receive user input that indicates which of the page regions or page attributes are of interest and need to be extracted. For example, through the GUI, the user may provide data which indicates that in each product, listed on a particular training web page, the attributes of interest are: the title, the product image, the product description, and the price. The user input received in the GUI is then converted to appropriate annotations, and the annotations are transferred to the corresponding nodes of the DOM representation of the particular training web page. The annotations from the DOM representation are then mapped to, and stored in association with, the corresponding nodes in the wrapper that represents the generalized structure of the web pages in the shopping web site.

In this manner, the techniques described herein provide for generating a wrapper that represents the generalized structure of a set of training web pages, where the wrapper also includes annotations that indicate a set of attributes of interest that are included in each of multiple records stored in the training web pages.

### Record Boundary Detection and Wrapper Modification

After an annotated wrapper is generated, each annotated page is processed in turn to determine the record boundaries and, in some embodiments, to generate records and to capture the characteristics of the annotated attributes.

For example, in one embodiment, the annotated wrapper is examined and the lowest common ancestor (LCA) nodes are identified for those wrapper nodes that are annotated as corresponding to attributes of interest. The LCA nodes are then marked as boundary nodes that indicate record boundaries that delimit one record from another record on the same training web page. Where multiple repeating records appear under the same parent node in the DOM representation of the training web page, a special LCA node (e.g., a STAR node) is inserted in the wrapper as a boundary node to delimit the multiple records from one another and to represent the pattern or patterns according to which the multiple records appear on the training web page.

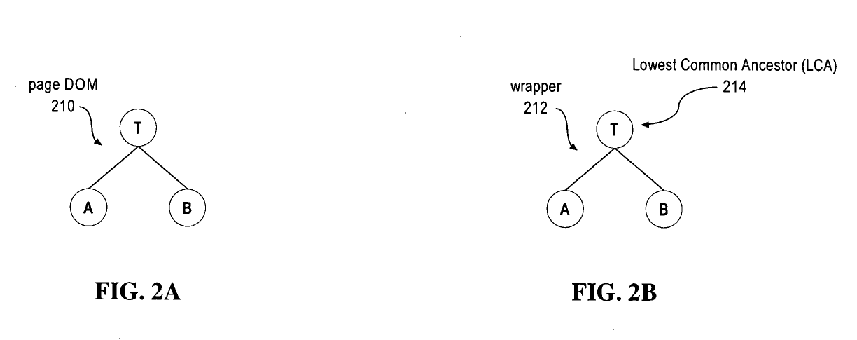

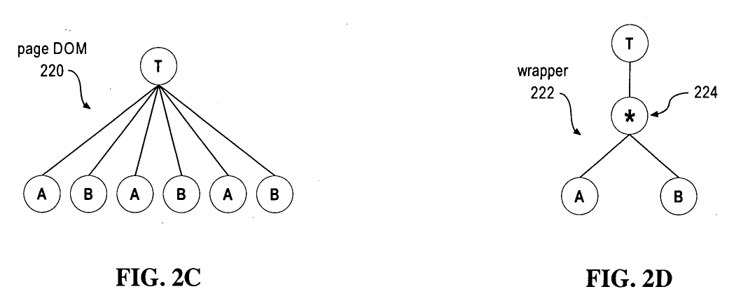

In embodiments in which record generation and annotated attribute discrimination is performed in addition to boundary detection, the detected record boundaries can potentially shift as more annotations on additional training web pages are processed. This can happen, for example, if the first processed web page has only one record made up of two sibling nodes, and second processed web page has multiple records, where the nodes of all records appear as siblings. For example, FIG. 2A illustrates a portion of the DOM representation 210 of a web page in which one record is made up of the two sibling nodes A and B, and FIG. 2C illustrates a portion of the DOM representation 220 of a different web page that has multiple records, where the nodes A and B of all records appear as siblings under node T. In this case, after processing the first web page, the record boundary will be the wrapper node that corresponds to the parent node of the annotated nodes in the DOM representation. This is illustrated in FIG. 2B, in which wrapper portion 212 includes LCA node 214 as the boundary node, where the LCA node 214 corresponds to the parent node T from DOM representation 210 in FIG. 2A. However, when the second web page is processed, the multiple records are delimited by a STAR node that is inserted in the wrapper as the parent node of the nodes that make up the multiple records. In this case, after processing the second web page, the record boundary is shifted down to the STAR node that is used as the boundary node. This is illustrated in FIG. 2D, in which wrapper portion 222 (which corresponds to the DOM representation 220 in FIG. 2C) includes STAR node 224 as the boundary node for the multiple records that comprise the repeating sibling nodes A and B. The techniques described herein also provide for tracking multiple LCA nodes in cases where the record structure of the multiple records varies at the top level of the DOM representation of the web page being processed.

The techniques described herein use the nodes of the wrapper to determine the record boundaries of multiple records in a web page. Since the wrapper represents the generalized structure of a set of training web pages, using the LCA nodes of the wrapper (as opposed to the nodes in the DOM representation of an annotated page) allows for more accurate detection of the record boundaries. Further, in some cases, a set of sibling nodes in the DOM representation can form a record, in which case there would be no single node in the page DOM representation that can indicate the record boundary. In these cases, however, according to the techniques described herein, the corresponding wrapper would include, as a boundary node, a STAR node that is inserted as a parent over the repeating set of nodes that form the sibling records.

After detecting the record boundaries, the techniques described herein provide for modifying the corresponding wrapper to include the one or more boundary nodes that represent the detected record boundaries. In the modified wrapper, the one or more boundary nodes indicate the record boundaries of the multiple records that are present in the set of training web pages from which the wrapper is generated. For example, the modified wrapper would include as boundary nodes any LCA nodes and any STAR nodes that indicate the detected record boundaries. Where the record boundaries of multiple repeating records are identified by a STAR node, the STAR node is present in the wrapper as the parent node of the multiple repeating records in conformance with the pattern according to which the multiple repeating records appear in the underlying training web pages. In some embodiments, a record generation module may generate multiple records from the training web pages and may also determine and delimit the set of immediate child nodes under each record.

### Record Generation

According to the techniques described herein, a multi entity web page may include one or more records and this multiplicity would be captured by STAR nodes in the corresponding wrapper.

In one embodiment, a record generation module (or a set of software components operable to perform similar functionality) exploits the property of the STAR nodes in the wrapper and determines when to generate a record. To generate the records from a multi entity web page, the record generation module traverses the DOM representation of the web page in a breadth-first, left-to-right manner and outputs a record when a pattern under a record boundary is completed. While traversing a current node in the DOM representation, the record generation module first matches the current DOM node to a portion of the wrapper and determines, from the matched portion of the wrapper, a first list of possible boundary nodes for the current DOM node and a second list of possible boundary nodes for a previous DOM node that was traversed immediately prior to the current DOM node. The record generation module then determines a difference set between the first list of possible boundary nodes and the second list of possible boundary nodes and examines the determined difference set. When the difference set is not empty, a record completion is detected and the annotated nodes associated with the nodes in the difference set are outputted as a record. When the difference set is empty and the current DOM node is to the left of the previous DOM node in the DOM representation, then a record completion is also detected and the annotated nodes associated with the nodes in the difference set are outputted as a record. In this manner, the techniques described herein provide for detecting record completion during the process of record generation.

In one operational example, a record generation module (or one or more equivalent software components) may be implemented to generate records by performing the following functionality:

1. The record generation module traverses the DOM representation of the web page being processed in a breadth-first, left-to-right manner. While traversing, at each node in the DOM representation, the record generation module determines the wrapper mapping or portion that corresponds to the current DOM node (also denoted herein as the “domNode”).

2. During the traversal, the record generation module maintains two wrapper nodes: (a) the current wrapper node (also denoted herein as “wrNode”) that maps to the current DOM node domNode; and (b) the previous wrapper node (also denoted herein as “prevWrNode”) that maps to the previous DOM node that was traversed immediately prior to the domNode.

3. If the current wrapper node wrNode is a descendant, in the wrapper tree, of a non-operator boundary node (e.g., an LCA node that does not correspond to STAR, OP, or OR operators) that is marked as annotated record, then the record generation module outputs the sub-tree under the current DOM node domNone. Else, if the current wrapper node wrNode is a descendant, in the wrapper tree, of a STAR node (also denoted herein as “sNode”) which is marked as annotated record, then the record generation module inserts the current DOM node domNode in a list of record nodes (also denoted herein as “recList”) corresponding to sNode. The list of record nodes recList is a set of DOM nodes that form a record corresponding to an annotated STAR node.

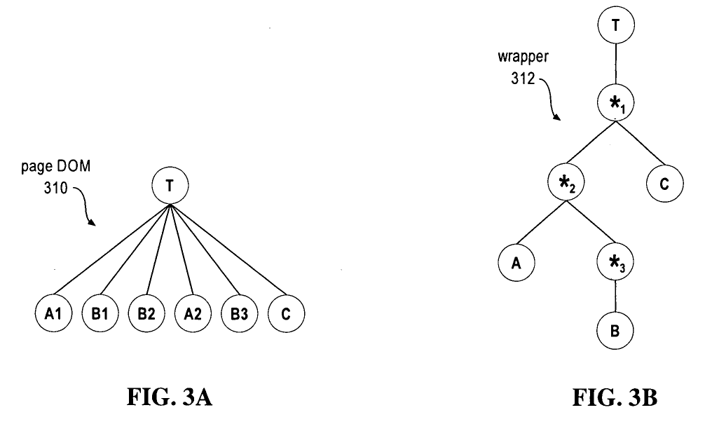

4. The record generation module then determines a list of STAR nodes (also denoted herein as “wrStarList”) that are ancestors of the current wrapper node wrNode, and a list of STAR nodes (also denoted herein as “prevWrStarList”) that are ancestors of the previous wrapper node prevWrNode. Each list of STAR nodes is calculated from the wrapper node until a non-operator node is reached and is stored in reverse order. For example, in FIG. 3B, the list of STAR nodes in wrapper portion 312 for node A is (*1, *2); the list of STAR nodes in wrapper portion 312 for node B is (*1, *2, *3); and the list of STAR nodes in wrapper portion 312 for node C is (*1).

5. While traversing the DOM representation of the web page being processed, at each current DOM node domNode, the record generation module calculates the difference set (denoted as “S”) between prevWrStarList and wrStarList. The difference set S signifies the completion of one or more record patterns under the STAR nodes belonging to the difference set S. For example, one may consider FIGS. 3A and 3B. When traversing the portion of DOM representation 310 from left to right and shifting from node B3 to node C, the difference set S is calculated as {*2, *3} which is the difference between prevWrStarList (which is for node B3 and includes (*1, *2, *3)) and wrStarList (which is for current node C and includes (*1)). This difference set S indicates that the record patterns under STAR nodes *2 and *3 are completed.

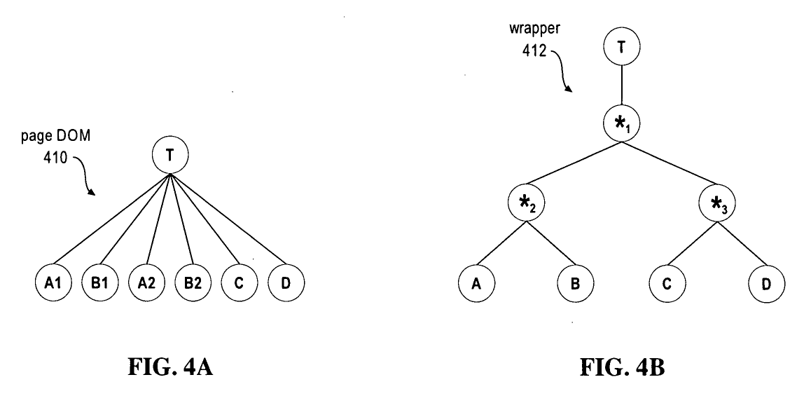

6. After determining the difference set S, the record generation module checks to determine whether S is empty and whether the position of the current wrapper node wrNode is to the left of or at the same position as the previous wrapper node prevWrNode. When the record generation module determines that the difference set S is empty, then the record generation module checks for the last STAR node in prevWrStarList. If that node is annotated as a record, then the record generation module outputs the list of record nodes recList corresponding to that STAR node and empties the recList. For example, one may consider FIGS. 4A and 4B. When traversing the portion of DOM representation 410 from left to right and shifting from node B1 to node A2, the difference set S is calculated as NULL (or empty) because, according to wrapper portion 412, both nodes B and A have the same list of STAR nodes that includes (*1, *2). However, since the position of the current wrapper node wrNode (corresponding to node A) is to the left of the previous wrapper node prevWrNode (corresponding to node B) in wrapper portion 412, the record generation module determines that the pattern under the last STAR node *2 is completed. The list of record nodes recList for STAR node *2 is outputted. From FIG. 4A, according to the techniques described herein, this recList is determined to include nodes (A1, B1).

7. When the record generation module determines that the difference set S is not empty, then the record generation module processes each STAR node (also denoted herein as “N”) in the difference set S, and checks to determine whether the position of the current wrapper node wrNode is to the left of or at the same position as the previous wrapper node prevWrNode. For each STAR node N in the difference set S, the record generation module determines whether STAR node N is annotated as a record. If STAR node N is annotated as a record, then the record generation module outputs the list of record nodes recList corresponding to that STAR node and empties the recList. For example, one may consider FIGS. 3A and 3B. When traversing the portion of DOM representation 310 from left to right and shifting from node B3 to node C, the difference set S is calculated as {*2, *3} because node C has a wrStarList that includes (*1) and node B has a prevWrStarList that includes (*1, *2, *3). Thus, the record generation module determines that the patterns for both STAR node *2 and STAR node *3 are completed, and outputs the current list of record nodes recList. From FIG. 3A, according to the techniques described herein this recList is determined to include nodes (A2, B3).

The record generation module then checks to determine whether the position of the current wrapper node wrNode is to the left of or at the same position as the previous wrapper node prevWrNode. When the position of the current wrapper node wrNode is either to the left of or at the same position as the previous wrapper node prevWrNode, the record generation module checks for the last common STAR node in prevWrStarList and wrStarList. If that last common STAR node is annotated as a record, then the record generation module outputs the recList corresponding to that last common STAR node. For example, consider FIGS. 3A and 3B. When traversing the portion of DOM representation 310 from left to right and shifting from node B2 to node A2, the last common STAR node in the difference set S is *2. This is because node A has a wrStarList that includes (*1, *2), node B has a prevWrStarList that includes (*1, *2, *3), and therefore the difference set S includes {*3}, which indicates that the last common STAR node is *2, as illustrated in wrapper portion 312. Thus, the record generation module determines that the record pattern under STAR node *2 is completed. If STAR node *2 is marked as a record, then the record generation module outputs the list of record nodes recList for that node. From FIG. 3A, according to the techniques described herein this recList is determined to include nodes (A1, B1, B2).

### Learning and Attribute Value Extraction From Records

After the multiple records have been generated from a multi entity web page, each record is passed through a filter mechanism that discriminates the annotated attributes from non annotated regions in the record, learns variations in the attribute characteristics, and ultimately extracts the values of the annotated attributes from the record. During extraction from annotated web pages, according to the techniques described herein, the filter mechanism discerns the annotated attributes and learns the attribute characteristics only from an extracted record and not from the entire web page from which the record was extracted.

In some embodiments, during extraction from non-annotated web pages, a process similar to the record boundary detection and record generation described heretofore may be used to detect records from the non-annotated web pages and to dynamically adjust the record boundaries indicated in the corresponding wrapper. When a new multi entity web page is received, the structure of the new web page is examined and a wrapper that represents a similar generalized structure is determined or selected from a set of available wrappers. In this manner, the new web page is associated with structurally similar training web pages and is mapped to an annotated wrapper that represents the generalized structure of the training web pages. Next, the record boundaries in the new web page are detected and adjusted in case they have shifted due to the changes introduced by the new page in the wrapper. The records from the new web page are then generated based on the wrapper. Thereafter, each record is processed independently to extract the values of the desired attributes: candidate attributes are generated, scored, and selected using the filter mechanism. The output of this extraction process is the set of records from the new page with the corresponding attribute values.

In one embodiment, attributes may be learned and attribute values may be extracted from records in a manner that is similar to that used in the techniques described in co-pending U.S. patent application Ser. No. 11/938,736, filed on Nov. 12, 2007 and entitled “Extracting Information Based On Document Structure And Characteristics Of Attributes”, the entire contents of which are hereby incorporated by reference as if fully set forth herein, and which is referred to hereinafter as the “'736 application”. The techniques described in the '736 application provide for inducing or otherwise learning a filter from a document structure and characteristics of attributes.

According to the techniques described in the '736 application, a filter may be generated or otherwise determined from an annotated wrapper. The filter represents two aspects of the training web pages from which the annotated wrapper is generated: the structure of the training web pages (e.g., the structure as represented by markup language tags); and some of the content features around the page regions that are annotated as being of interest. These content features may be some content-specific HTML properties—for example, in some web pages, prices may be followed by a certain price tag, the product title may be in bold typeface (i.e., may be enclosed in “bold” tags), etc. In this manner, the filter “learns” which of the content features are associated with the annotated page regions, and determines the page properties which discriminate a particular page region of interest from the other regions of the page. Thus, the filter represents both the structure features and the relevant content features of the annotated regions in an annotated page. When a new, non-annotated web page is received and processed, an annotated wrapper is matched to this web page and a set of nodes are generated that match to the filter around the page regions of interest. The filter is then used to determine and filter candidate page regions that are most likely to match the information of interest, and the content of the winning candidate region is extracted out.

It is noted that the techniques described in the '736 application learn filters based on the content and structure of an entire web page and extract attribute values for a single record from a web page. The techniques described in the present application, however, apply the filter learning mechanism of the '736 application to an individual record that is extracted from a web page, where the web page includes multiple records. Further, the techniques described in the present application apply the attribute extraction mechanism of the '736 application to each individual record as opposed to the entire web page. In this manner, the techniques described herein provide for high precision extraction of multiple entities that may be stored as multiple records in the same web page.

### Hardware Overview

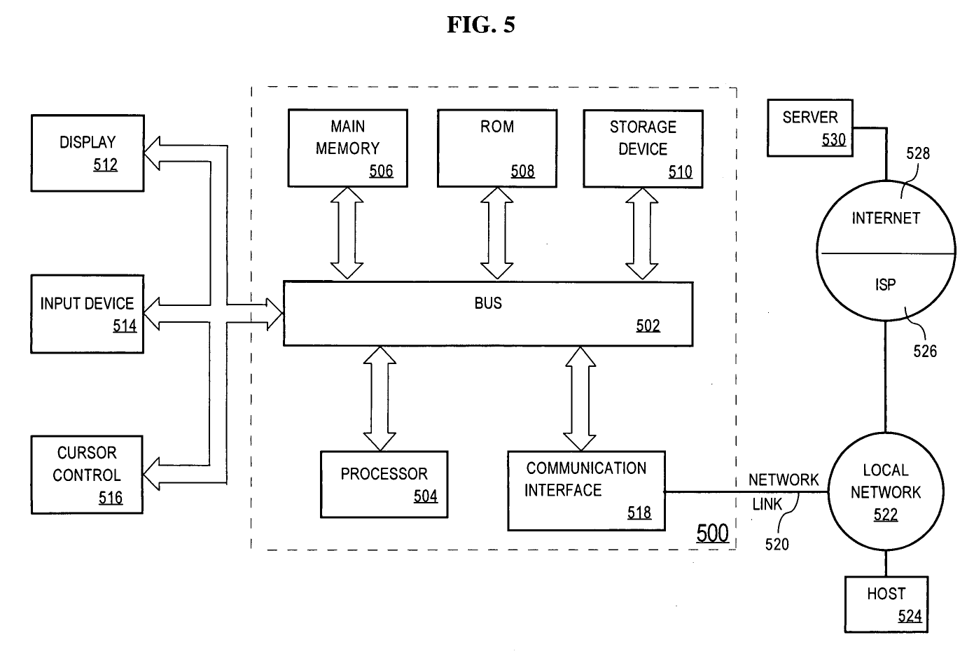

The techniques described herein for high precision multi entity extraction may be implemented in various operational contexts and on various kinds of computer systems that are programmed to be special purpose machines pursuant to instructions from program software. For purposes of explanation, FIG. 5 is a block diagram that illustrates an example computer system 500 upon which embodiments of the techniques described herein may be implemented.

Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein for high precision multi entity extraction. According to one embodiment, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operate in a specific fashion. In an embodiment implemented using computer system 500, various computer-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine such as, for example, a computer system.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
accessing a wrapper that represents a generalized structure of a set of training web pages, wherein the wrapper includes one or more annotations that indicate a set of attributes that are included in each of a plurality of records;
based on nodes included in the wrapper, determining record boundaries that delimit the plurality of records within any training page of the set of training web pages;
modifying the wrapper to include one or more boundary nodes, wherein the one or more boundary nodes indicate the record boundaries of the plurality of records within the set of training web pages; and
extracting multiple records from a web page, wherein extracting the multiple records comprises detecting record completions based at least on the wrapper and on a document object model (DOM) representation of the web page.

2. The method of claim 1, wherein:
determining the record boundaries comprises identifying one or more lowest common ancestor nodes for those nodes in the wrapper that are associated with the one or more annotations; and
modifying the wrapper comprises indicating, in the wrapper, the one or more boundary nodes that respectively correspond to the one or more lowest common ancestor nodes.

3. The method of claim 1, wherein extracting the multiple records from the web page comprises traversing the DOM representation of the web page, wherein while traversing a current node in the DOM representation further performing:
matching the current node to a portion of the wrapper;
determining, from the portion of the wrapper, a first list of possible boundary nodes for the current node and a second list of possible boundary nodes for a previous node that was traversed immediately prior to the current node;
determining a difference set between the first list of possible boundary nodes and the second list of possible boundary nodes;
determining whether at least one record completion is detected based at least on the difference set; and
outputting at least one record when said at least one record completion is detected.

4. The method of claim 3, wherein determining whether said at least one record completion is detected further comprises:
determining whether the difference set is not empty; and
determining that said at least one record completion is detected when the difference set is not empty.

5. The method of claim 3, wherein:
traversing the DOM representation of the web page comprises traversing the DOM representation breadth-first and left-to-right; and
determining whether said at least one record completion is detected further comprises:
determining whether the difference set is empty;
when the difference set is empty, determining whether the current node is to the left of the previous node in the DOM representation; and
determining that said at least one record completion is detected when the current node is to the left of the previous node in the DOM representation.

6. The method of claim 1, further comprising processing the multiple records in order to extract, from each record, attributes values of the set of attributes that are included in said each record.

7. The method of claim 6, wherein processing the multiple records further comprises:
from a first record of the multiple records, determining a filter that discriminates among the set of attributes; and
applying the filter to each individual record of the multiple records in order to extract the attribute values from said each individual record.

8. The method of claim 6, wherein processing the multiple records further comprises:
detecting a structural variation between the web page and the wrapper; and
modifying the wrapper to reflect the structural variation by modifying the record boundaries through corresponding changes to the one or more boundary nodes.

9. The method of claim 1, wherein at least one of the one or more boundary nodes corresponds to a STAR operator, wherein the STAR operator is used in the wrapper to represent one or more repeating patterns, within the set of training web pages, of one or more attributes from the set of attributes.

10. The method of claim 1, wherein the web page is a training page from the set of training web pages.

11. The method of claim 1, wherein the web page is not included in the set of training web pages, and the method further comprises determining that the web page has a page structure that is similar to the generalized structure of the set of training web pages.

12. The method of claim 1, wherein the set of training web pages are extracted from a plurality of web sites having similar page structures.

13. The method of claim 1, wherein the set of attributes includes multiple groupings of one or more attributes, wherein the multiple groupings respectively represent the multiple records.

14. A computer-readable storage medium storing one or more sequences of instructions which, when executed by one or more processors, cause the one or more processors to perform steps comprising:
accessing a wrapper that represents a generalized structure of a set of training web pages, wherein the wrapper includes one or more annotations that indicate a set of attributes that are included in each of a plurality of records;
based on nodes included in the wrapper, determining record boundaries that delimit the plurality of records within any training page of the set of training web pages;
modifying the wrapper to include one or more boundary nodes, wherein the one or more boundary nodes indicate the record boundaries of the plurality of records within the set of training web pages; and
extracting multiple records from a web page, wherein extracting the multiple records comprises detecting record completions based at least on the wrapper and on a document object model (DOM) representation of the web page.

15. The computer-readable storage medium of claim 14, wherein:
the instructions that cause the one or more processors to perform determining the record boundaries comprise instructions which, when executed by the one or more processors, cause the one or more processors to perform identifying one or more lowest common ancestor nodes for those nodes in the wrapper that are associated with the one or more annotations; and
the instructions that cause the one or more processors to perform modifying the wrapper comprise instructions which, when executed by the one or more processors, cause the one or more processors to perform indicating, in the wrapper, the one or more boundary nodes that respectively correspond to the one or more lowest common ancestor nodes.

16. The computer-readable storage medium of claim 14, wherein the instructions that cause the one or more processors to perform extracting the multiple records from the web page comprise instructions which, when executed by the one or more processors, cause the one or more processors to perform traversing the DOM representation of the web page, wherein while traversing a current node in the DOM representation the instructions further cause the one or more processors to perform:
matching the current node to a portion of the wrapper;
determining, from the portion of the wrapper, a first list of possible boundary nodes for the current node and a second list of possible boundary nodes for a previous node that was traversed immediately prior to the current node;
determining a difference set between the first list of possible boundary nodes and the second list of possible boundary nodes;
determining whether at least one record completion is detected based at least on the difference set; and
outputting at least one record when said at least one record completion is detected.

17. The computer-readable storage medium of claim 16, wherein the instructions that cause the one or more processors to perform determining whether said at least one record completion is detected further comprise instructions which, when executed by the one or more processors, cause the one or more processors to perform:
determining whether the difference set is not empty; and
determining that said at least one record completion is detected when the difference set is not empty.

18. The computer-readable storage medium of claim 16, wherein:
the instructions that cause the one or more processors to perform traversing the DOM representation of the web page comprise instructions which, when executed by the one or more processors, cause the one or more processors to perform traversing the DOM representation breadth-first and left-to-right; and
the instructions that cause the one or more processors to perform determining whether said at least one record completion is detected further comprise instructions which, when executed by the one or more processors, cause the one or more processors to perform:
determining whether the difference set is empty;
when the difference set is empty, determining whether the current node is to the left of the previous node in the DOM representation; and
determining that said at least one record completion is detected when the current node is to the left of the previous node in the DOM representation.

19. The computer-readable storage medium of claim 14, wherein the one or more stored sequences of instructions further comprise instructions which, when executed by the one or more processors, cause the one or more processors to perform a step of processing the multiple records in order to extract, from each record, attributes values of the set of attributes that are included in said each record.

20. The computer-readable storage medium of claim 19, wherein the instructions that cause the one or more processors to perform processing the multiple records further comprise instructions which, when executed by the one or more processors, cause the one or more processors to perform:
from a first record of the multiple records, determining a filter that discriminates among the set of attributes; and
applying the filter to each individual record of the multiple records in order to extract the attribute values from said each individual record.

21. The computer-readable storage medium of claim 19, wherein the instructions that cause the one or more processors to perform processing the multiple records further comprise instructions which, when executed by the one or more processors, cause the one or more processors to perform:
detecting a structural variation between the web page and the wrapper; and
modifying the wrapper to reflect the structural variation by modifying the record boundaries through corresponding changes to the one or more boundary nodes.

22. The computer-readable storage medium of claim 14, wherein at least one of the one or more boundary nodes corresponds to a STAR operator, wherein the STAR operator is used in the wrapper to represent one or more repeating patterns, within the set of training web pages, of one or more attributes from the set of attributes.

23. The computer-readable storage medium of claim 14, wherein the web page is a training page from the set of training web pages.

24. The computer-readable storage medium of claim 14, wherein the web page is not included in the set of training web pages, and wherein the one or more stored sequences of instructions further comprise instructions which, when executed by the one or more processors, cause the one or more processors to perform a step of determining that the web page has a page structure that is similar to the generalized structure of the set of training web pages.

25. The computer-readable storage medium of claim 14, wherein the set of training web pages are extracted from a plurality of web sites having similar page structures.

26. The computer-readable storage medium of claim 14, wherein the set of attributes includes multiple groupings of one or more attributes, wherein the multiple groupings respectively represent the multiple records.
